(19) United States
(12) Patent Application Publication
(10) Pub. No.: US 2022/0181751 A1
(43) Pub. Date: Jun. 9, 2022

(54) Apparatus for Contacting a First Battery Unit to a Second Battery Unit, and Battery Arrangement

(71) Applicant: Webasto SE, Stockdorf (DE)

(72) Inventors: Jochen Haussmann, Stockdorf (DE); Michael Schink, Stockdorf (DE); Tobias Tofaute, Stockdorf (DE)

(21) Appl. No.: 17/598,833

(22) PCT Filed: Mar. 30, 2020
(86) PCT No.: PCT/EP2020/058969

§ 371 Date: Sep. 27, 2021

(30) Foreign Application Priority Data
Mar. 28, 2019 (DE) 102019107993.4

(51) Int. Cl. H01M 50/51; H01M 50/204

(52) U.S. Cl. CPC H01M 50/51; H01M 50/249; H01M 2220/20; H01M 50/204

(57) ABSTRACT

The present invention relates to an apparatus for contacting a first battery unit to a second battery unit, comprising an electrically conductive element which has, on a first end, a first contact surface for electrically contacting the first battery unit and, on a second end, a second contact surface for electrically contacting the second battery unit, and a guide element extending in an axial direction between the first contact surface and the second contact surface, wherein the guide element has a guide surface for guiding the second battery unit in the axial direction relative to the first battery unit during assembly of the first battery unit and of the second battery unit, and wherein the guide element is designed as electrical insulation of the conductive element, and to a battery arrangement comprising the apparatus.

### CROSS-REFERENCE TO RELATED APPLICATIONS

This application is a 35 U.S.C. § 371 National Stage Entry of International Application No. PCT/EP2020/058969 filed Mar. 30, 2020, which claims the priority benefit of German Patent Application Serial Number DE 102019107993.4 filed Mar. 28, 2019, all of which are incorporated herein by reference in their entirety for all purposes.

### TECHNICAL FIELD

The present invention relates to a device for establishing contact between a first battery unit and a second battery unit, and a battery arrangement.

### BACKGROUND

In the field of battery arrangements, for example vehicle batteries, it is known for these to be composed of a plurality of battery units, wherein the individual battery units can in turn have a plurality of battery cells. Consequently, the battery units having a plurality of battery cells form high-voltage units. For the mutual electrical connection, or contacting, of the individual battery units during the assembly of the battery arrangement, flexible, electrically conductive connecting elements, most commonly in the form of cables, are currently endangered by openings of the individual battery units or by openings of a battery housing of the battery arrangement during assembly. Since these cables do not have a specified position and can alter their alignment in a more or less unpredictable manner, this represents a safety risk both for the battery arrangement and, in particular, also for a person assembling the battery arrangement. This is particularly the case since the battery housing or the component having the opening of the battery unit, for example a base of the battery unit, are most commonly made from a conductive metallic material.

For the assembly of conventional battery arrangements, additional effort is required to protect the components of the battery arrangement and to protect the persons and technical apparatus involved in assembling the battery, which is reflected in an increased assembly time and in additional devices for improving the functional safety and the operational safety.

### Presentation of the Invention

Starting with the known prior art, an object of the present invention is to provide an improved battery arrangement and an improved device for establishing contact between a first battery unit and a second battery unit.

The above object is achieved by a device for establishing contact between a first battery unit and a second battery unit having the features of claim 1. Advantageous developments are revealed in the subclaims, the description and the accompanying figures.

Accordingly, a device for establishing contact between a first battery unit and a second battery unit is proposed, comprising an electrically conductive element, which has, at a first end, a first contact surface for electrically contacting the first battery unit and, at a second end, a second contact surface for electrically contacting the second battery unit, and a guide element extending between the first contact surface and the second contact surface in an axial direction, wherein the guide element has a guide surface for guiding the second battery unit in an axial direction relative to the first battery unit during the assembly of the first battery unit and the second battery units, and wherein the guide element is designed as electrical insulation of the conductive element.

As a result of the device which is constructed in this way, a specified spacing between the first contact surface, which is provided for contacting the first battery unit, and the second contact surface, which is provided for contacting the second battery unit, can be provided on the one hand.

In this case, the first contact surface and the second contact surface are always located in a fixed position with respect to one another so that a more or less unpredictable movement or repositioning of the second contact surface during the assembly of the first battery unit and second battery unit is prevented.

Furthermore, a specified guidance of the second battery unit relative to the first battery unit can be provided via the guide surface of the guide element, so that it is possible to dispense with additional guide elements on the one hand, or these can at least be reduced in terms of their number, and yet incorrect positioning of the second battery unit with respect to the first battery unit can be prevented during assembly.

Touch protection is furthermore provided by the device via the insulating effect of the guide element, in other words as a result of the guide element being designed as electrical insulation of the conductive elements, which touch protection can prevent persons involved in the assembly from coming into contact with the conductive element. Moreover, as a result of the insulation, the conductive element can be prevented from coming into contact with conductive components of the first battery unit and/or the second battery unit which are not provided for the contacting of the first battery unit and/or the second battery unit. Therefore, the formation of unintentional short circuits or unintentional discharges can also be prevented. Both the functional safety and the operational safety can thus be increased.

Consequently, during assembly of the first battery unit and the second battery unit, in particular when seating the second battery unit on the first battery unit, it is also possible to guide the second battery unit with respect to the first battery unit and to bring it into a specified spatial position whilst reducing, or even fully eliminating, the risk of unintentional and/or harmful electrical contact during assembly.

As a result, the assembly of the first battery unit and the second battery unit by means of the device can take place without requiring essential additional apparatus for ensuring functional safety and operational safety. This can reduce the assembly effort and the required assembly time compared to conventional battery arrangements.

Furthermore, by using the device, the manufacture of a battery arrangement can be further automated compared to conventional battery arrangements. As a result of the above-mentioned points, the costs for producing a battery arrangement can be lowered accordingly compared to conventional battery arrangements.

If the guide element is formed continuously in the circumferential direction with respect to the axial direction, this enables circumferential touch protection for the conductive element, so that particularly high functional safety and particularly high operational safety are achieved.

The guide element preferably comprises an electrically insulating material, preferably a plastic or a plastic composite.

According to a further embodiment, the guide element has an outer cross-sectional profile, the form of which is designed in such a way that, in addition to the guidance of the second battery unit in the axial direction, a positioning of the second battery unit relative to the first battery unit is provided, preferably an angular positioning in relation to the axial direction in the circumferential direction. It can thus be ensured that the second battery unit is always orientated in a correct spatial position with respect to the first battery unit, or the possibility of an incorrect positioning of the second battery unit relative to the first battery unit can be eliminated.

It has been shown that particularly favorable guidance and positioning is enabled if the outer cross-sectional profile has a polygonal form, preferably a substantially triangular, quadrangular or hexagonal form, wherein preferably at least one corner of the polygonal outer cross-sectional profile is rounded.

To achieve further improved safety against accidental, unintentional touching of the second contact surface, in particular during assembly, the touch protection can extend beyond the second contact surface in the axial direction.

To this end, the touch protection advantageously has a side wall extending from the contact surface. Alternatively or additionally, the touch protection can have a frame structure, preferably a rod frame structure.

In order to provide particularly safe touch protection on the one hand and to moreover enable simple contacting of the second contact surface via a second contacting element of the second battery unit, the touch protection can have a preferably lateral insertion opening for inserting a second contacting element of the second battery unit. Alternatively, the insertion opening can also be aligned at the end face, in other words upwards from the second contact surface in the axial direction. As a result of the insertion opening, it is possible to additionally specify an alignment of a contact element of the second battery unit for contacting the second contact surface relative to the device.

If, in this case, a height and a width of the insertion opening are preferably each designed to be greater than a height and a width of the second contacting element, the second contacting element can be easily inserted into the insertion opening. Alternatively, the insertion open can also be upwardly open.

According to a further embodiment, a fastening element for providing a mechanical connection and/or a mechanical and electrical connection, preferably a threaded bore or a threaded pin, is provided on the first contact surface, and/or a fastening element for providing a mechanical connection and/or a mechanical and electrical connection, preferably a threaded bore or a threaded pin, is provided on the second contact surface. Safe and durable fastening of a contacting element on the contact surface and/or durable and safe electrical contacting can thus be achieved.

In order to facilitate the insertion of the device into an opening of the second battery unit during the assembly of the second battery unit and the first battery unit, the guide element can have an insertion portion extending from the second end in the direction of the first end, wherein the insertion portion preferably tapers in the direction of the second end, wherein the insertion portion is preferably designed to be at least partially conical and/or pyramidal, in other words in the manner of a truncated cone and/or a truncated pyramid, and/or has a phase at least on one edge.

The guide element preferably has a shoulder on which the second battery unit, preferably a base of the second battery unit, is seated so that a specified spacing between the first battery unit and the second battery unit can be provided.

Alternatively or additionally, the guide element can taper in the direction of the second end in the region of the guide surface, so that, with a corresponding design of the opening of the second battery part, a specified spacing between the first battery part and the second battery part can likewise be provided.

The object presented above is furthermore achieved by a battery arrangement having the features of claim 10. Advantageous developments are revealed in the subclaims and in this description and in the figures.

Accordingly, a battery arrangement is proposed, comprising a first battery unit and a second battery unit. The battery arrangement is further characterized in that the second battery unit is positioned relative to the first battery unit by a device according to one of the preceding embodiments and wherein the first battery unit electrically contacts the second battery unit via the device.

The advantages and effects mentioned above in relation to the device can be achieved analogously by the battery arrangement

It has been shown that the advantages and effects described above become particularly manifest when a further embodiment corresponding to the second battery unit is arranged above the first battery unit, wherein the device preferably extends from the first battery unit through an opening in a base element of the second battery arrangement in the direction of the second battery arrangement.

### BRIEF DESCRIPTION OF THE FIGURES

Preferred further embodiments of the invention are explained in more detail by the description below of the figures, in which:

FIG. 1 shows a schematic sectional view of a battery arrangement according to a first embodiment;

FIG. 2 shows a schematic sectional view of a battery arrangement according to a further embodiment;

FIG. 3 shows a schematic perspective side view of a device for the contacting of a first battery unit and a second battery unit according to a preferred embodiment;

FIG. 4 shows a schematic side view of the device of FIG. 3;

FIG. 5 shows a schematic perspective side view of a device for the contacting of a first battery unit and a second battery unit according to a further embodiment;

FIG. 6 shows a schematic side view of the device of FIG. 5;

FIG. 7 shows a schematic side view of a device for the contacting of a first battery unit and a second battery unit according to a further embodiment;

FIG. 8 shows a schematic side view of a device for the contacting of a first battery unit and a second battery unit according to a further embodiment;

FIG. 9 shows a schematic plan view of the device of FIG. 8;

FIG. 10 shows a schematic sectional view of a battery arrangement according to a further embodiment;

FIG. 11 shows a schematic sectional view of a battery arrangement according to a further embodiment; and

FIGS. 12A to 12F show schematic outer cross-sectional profiles of guide elements according to preferred embodiments.

### DETAILED DESCRIPTION OF PREFERRED EXEMPLARY EMBODIMENTS

Preferred exemplary embodiments are described below with reference to the figures. In this case, identical, similar or identically acting elements are denoted by the same reference signs in the figures and repeated description of these elements is omitted in some cases in order to avoid redundancy.

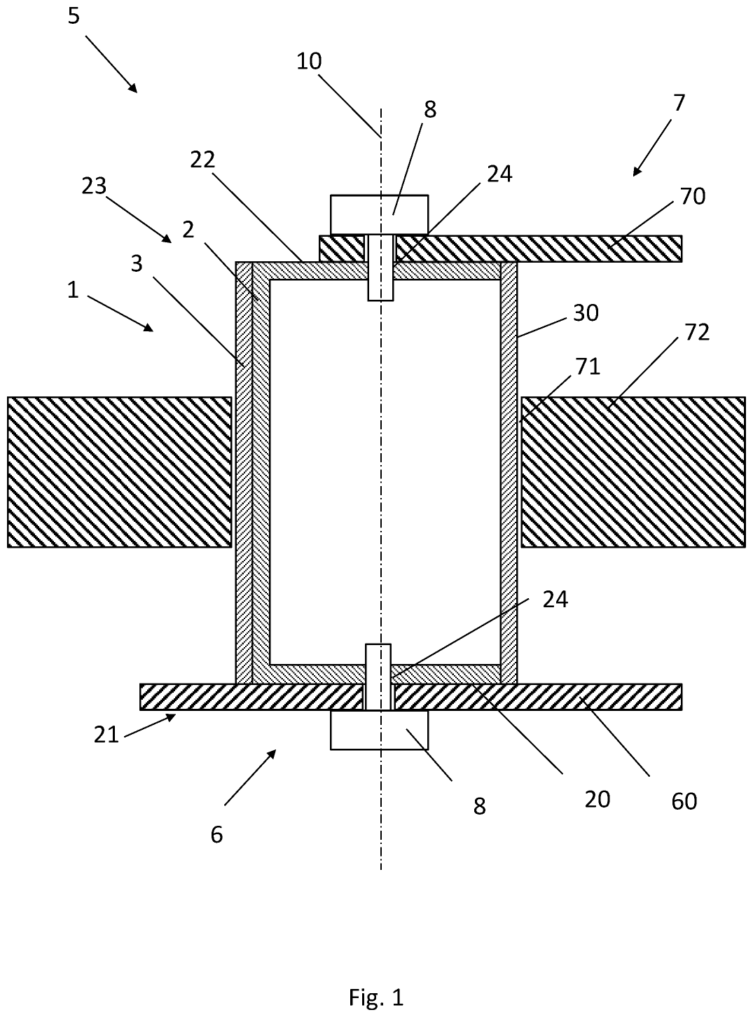

FIG. 1 shows a schematic sectional view of a battery arrangement 5 according to a first embodiment. The battery arrangement 5 has a first battery unit 6 and a second battery unit 7, which establish electrical contact with one another by means of a device 1 for establishing contact between the first battery unit 6 and the second battery unit 7. The second battery unit 7 is moreover positioned relative to the first battery unit 6 by the device 1.

The device 1 comprises an electrically conductive element 2, which has, at a first end 21, a first contact surface 20 for electrically contacting the first battery unit 6 and, at a second end 23, a second contact surface 22 for electrically contacting the second battery unit 7. The second contact surface 22 is arranged at a predetermined spacing from the first contact surface 20 in an axial direction 10 of the device 1. In other words, the electrically conductive element 2 extends from the first end 21 to the second end 23.

A fastening element in the form of a threaded bore 24 is provided on the first contact surface 20 for the purpose of providing a mechanical connection between the device 1 and the first battery unit 6. In the present case, a screw 8 is screwed into the threaded bore 24 and thus presses a first contacting element 60 of the first battery unit 6 against the first contact surface 20 so that a substantially planar, electrically conductive connection between the first contacting element 60 and the first contact surface 20 is provided.

Alternatively or additionally, the screw, in addition to the mechanical connection, can also provide electrical contacting between the first battery unit 6 and the electrically conductive element 2 if the screw comprises an electrically conductive material.

According to an alternative embodiment, the screw 8 can comprise an electrically non-conductive material, in other words an electrically insulating material. It can thus be achieved that, when the screw 8 is touched by a person, the person does not receive an electric shock.

Analogously, for the purpose of providing a mechanical connection and/or a mechanical and electrical connection to the second battery unit 7, a fastening element is likewise provided on the second contact surface 22—for example, again in the form of a threaded bore 24 here—into which a further screw 8 is screwed in order to press a second contacting element 70 of the second battery unit 7 against the second contact surface 22 and thus provide an electrically conductive connection between the above-mentioned components.

A guide element 3, which has a guide surface 30 on its radial outer side with respect to the axial direction 10, furthermore extends between the first contact surface 20 and the second contact surface 22 in the axial direction 10. The guide surface 30 is designed to guide the second battery unit 7 relative to the first battery unit 6 in the axial direction so that, during assembly of the first battery unit 6 and the second battery unit 7, the second battery unit 7 can be guided and positioned relative to the first battery unit 6 by means of the device 1 which has already been mounted on the first battery unit 6.

In the present case, the device 1 extends from the first battery unit 6 through an opening 71 in a base element 72 of the second battery unit 7 in the direction of the second battery unit 7. In this case, the base element 72 is guided by the guide surface 30 via the opening 71.

In the exemplary embodiment shown in FIG. 1, the second battery unit 7 and the first battery unit 6 are designed to be substantially identical. Both battery units 6, 7 each have a plurality of mutually electrically contacted battery cells (not shown), which are in turn each contacted by the first contacting element 60 or the second contacting elements 70. In the present case, the second battery unit 7 is furthermore arranged above the first battery unit 6. In other words, the first battery unit 6 and the second battery unit 7 form two planes of the battery arrangement 5, which lie one above the other.

The guide element 3 is furthermore designed as electrical insulation of the electrically conductive element 2. To this end, the guide element 3 comprises an electrically insulating material.

In order to provide circumferential insulation of the electrically conductive element 2 with respect to the axial direction 10 between the first contact surface 20 and the second contact surface 22, the guide element 3 is formed continuously in the circumferential direction in relation to the axial direction 10. In other words, the guide element 3 forms a sheath or sleeve which houses the electrically conductive element 2 and extends between the first end 20 and the second end 23 in the axial direction 10.

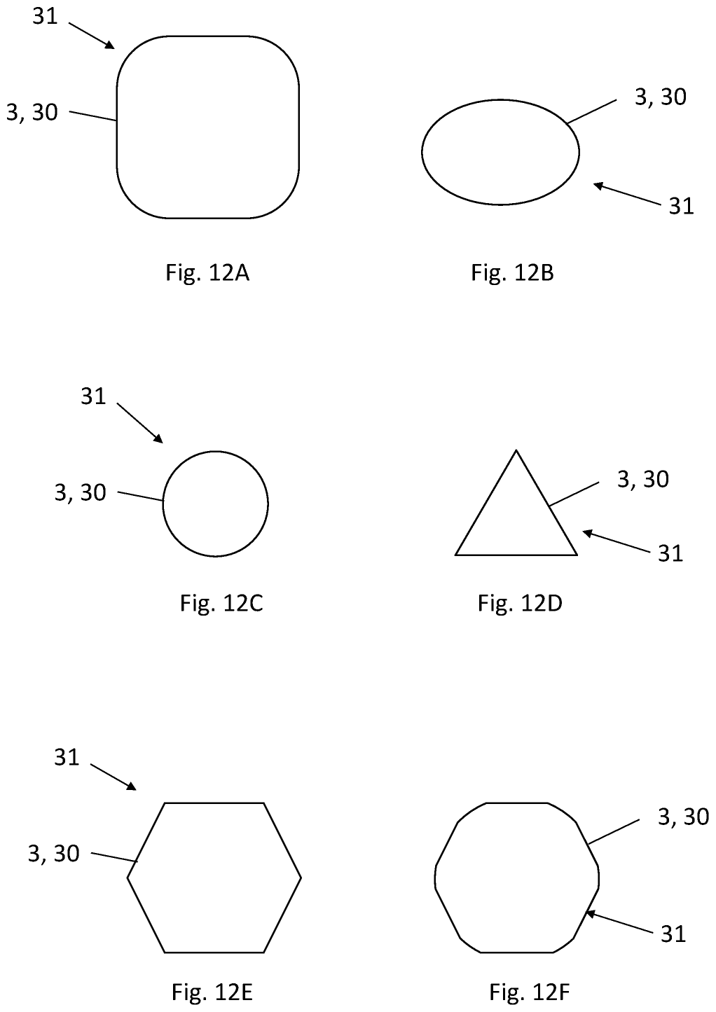

According to this exemplary embodiment, the guide element 3 has a substantially polygonal outer cross-sectional profile 31 perpendicularly to the axial direction 10 according to FIG. 12A. The guide element 3 can alternatively also have other outer cross-sectional profiles.

As revealed in FIG. 12 A, the outer cross-sectional profile 31 has a substantially rectangular form, wherein the corners are rounded. In other words, the outer cross-sectional profile 31 substantially has the form of a quadrangular profile.

As a result of this form of the outer cross-sectional profile 31, in addition to the guidance of the second battery unit 7 in the axial direction 10, a positioning of the second battery unit 7 relative to the first battery unit can moreover be provided, wherein an angular positioning in relation to the axial direction 10 is likewise provided in the circumferential direction owing to the polygonal form.

In this case, the term “angular positioning” should be understood such that a main alignment of the second battery unit 7 is specified with respect to a plane arranged perpendicularly to the axial direction 10. In other words, an angle or a vector of the main alignment of the second battery unit 7 which lies in the above-mentioned plane is specified by the form of the outer cross-sectional profile 31.

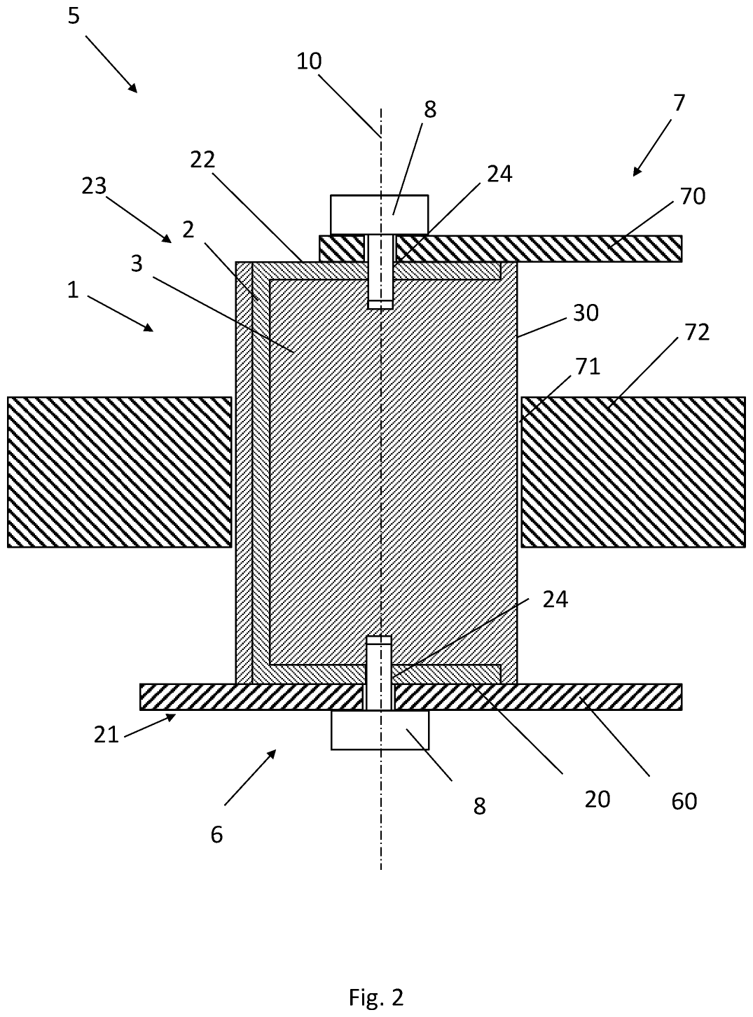

FIG. 2 shows a schematic sectional view of a battery arrangement 5 according to a further embodiment, which corresponds substantially to the battery arrangement 5 shown in FIG. 1.

In this exemplary embodiment, the electrically conductive element 2 is surrounded completely by the material of the guide element 3 up to the contact surfaces 20, 22.

Unlike in FIG. 1, the guide element 3 shown according to FIG. 2 is not provided such that it is hollow inside in the form of a sleeve, but is formed as a substantially continuous, closed solid body.

In this case, the threaded bores 24, which, as described above, serve as fastening elements of the device 1 with respect to the first battery unit 6 and the second battery unit 7, likewise extend through the conductive element 2 into the guide element 3 as a blind hole in each case.

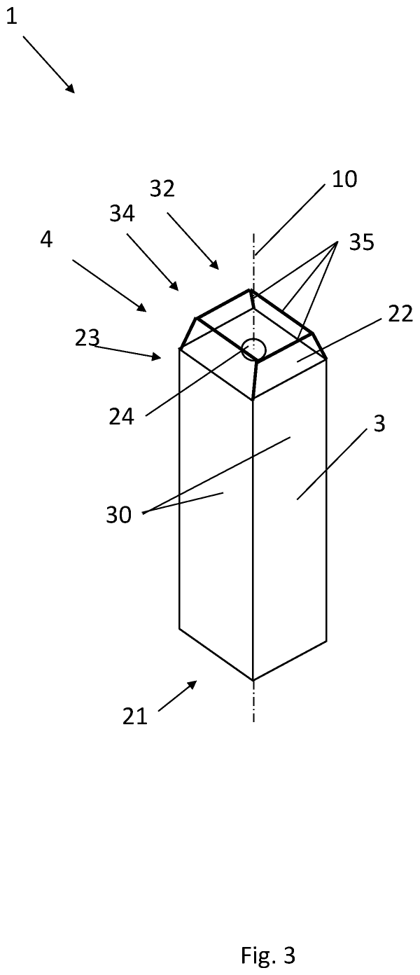

FIG. 3 shows a schematic perspective side view of a device 1 for the contacting of a first battery unit 6 and a second battery unit 7 according to a further preferred embodiment. The device 1 is designed substantially analogously to the device 1 shown in FIG. 1.

The device 1 in FIG. 3 moreover has touch protection 32 which extends beyond the second contact surface 22 in the axial direction 10. In the present case, the touch protection 32 is designed as a frame structure 34, wherein a plurality of rods 35 together form a rod frame structure.

In this case, the frame structure 34 substantially has the form of a truncated pyramid or a pyramidal form in relation to the guide element 3. The frame structure 34 furthermore consequently provides an insertion portion 4, which facilitates the sliding-on and centering of the base element 72 on the device 1 via the opening 71. In this case, the insertion portion 4 tapers in the direction of the second end 23 as seen in the axial direction 10.

In other words, the frame structure 34, on the one hand, provides the touch protection 32 for the second contact surface 22 and also the insertion portion 4 of the guide element 3.

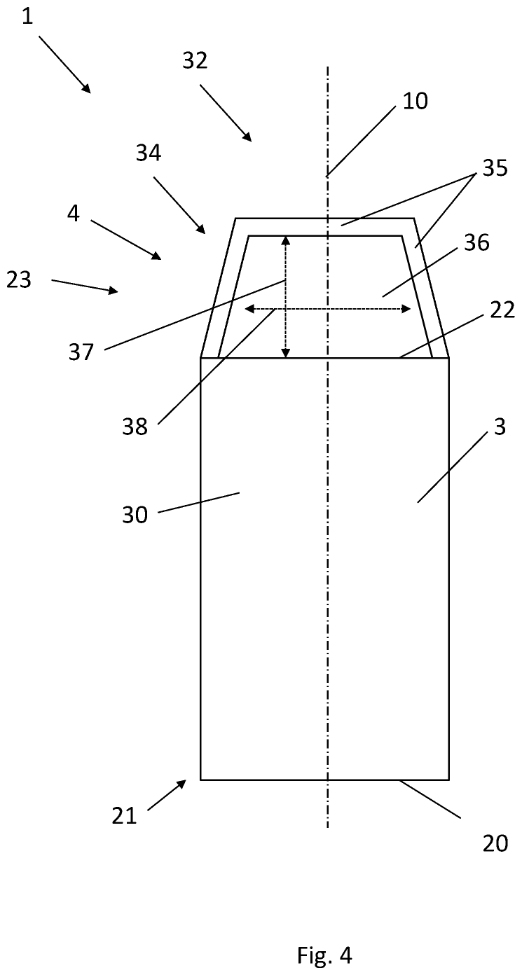

In FIG. 4, a side view of the device 1 of FIG. 3 is shown schematically. From this, the form of the frame structure 34 in the manner of a truncated pyramid can again be seen particularly clearly. As a result of the frame structure 34, lateral insertion openings 36 are furthermore provided, through which the second contacting element 70 can be inserted for assembly with the device 1 and, in particular, for contacting of the second contact surface 22.

In this case, a height 37 and a width 38 of an insertion opening 36 are each designed to be greater than a height and a width of the second contacting element 70 so that it is possible to easily insert the second contacting element 70 into the insertion opening 36.

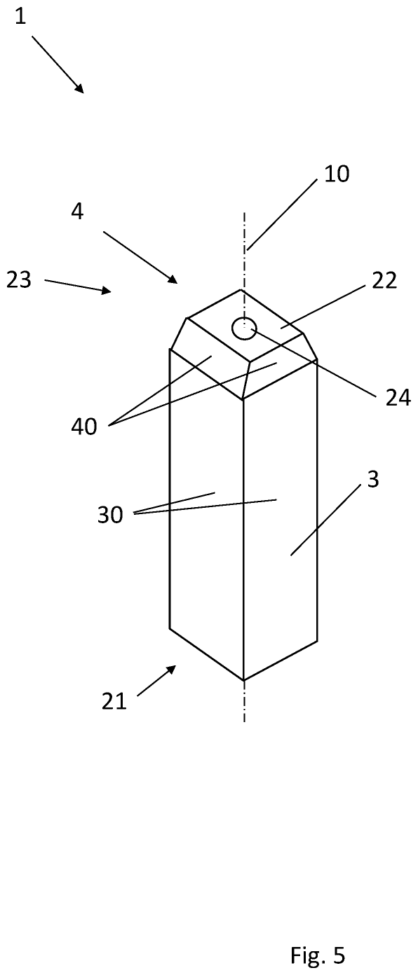

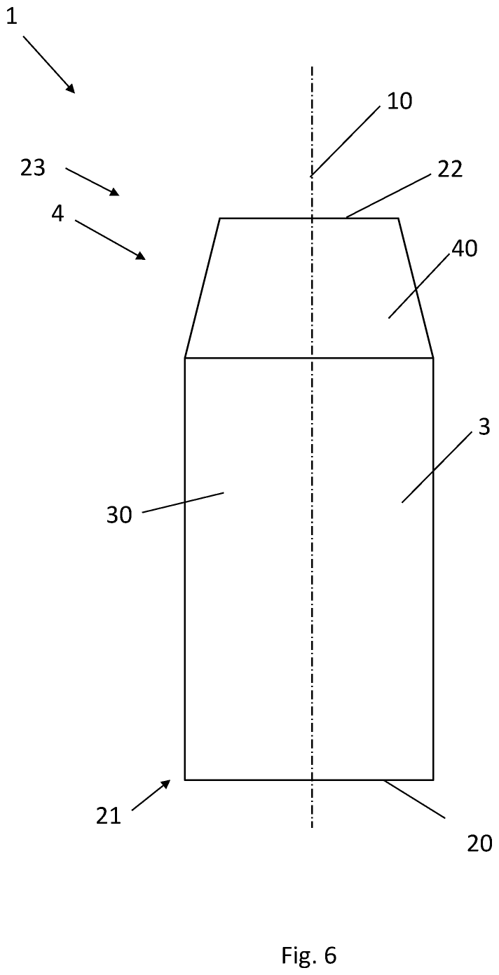

FIGS. 5 and 6 show a schematic perspective side view and a side view of a device 1 for the contacting of a first battery unit 6 and a second battery unit 7 according to a further embodiment. The device 1 corresponds substantially to that according to FIG. 1, wherein the device 1 has, at the second end 23, an insertion portion 4 which, as seen radially, tapers in the direction of the second end 23 in the direction of the axial direction 10. In other words, the insertion portion 4 is likewise formed substantially in the manner of a truncated pyramid. To this end, the edges of the contact surface 22 each have a phase 40.

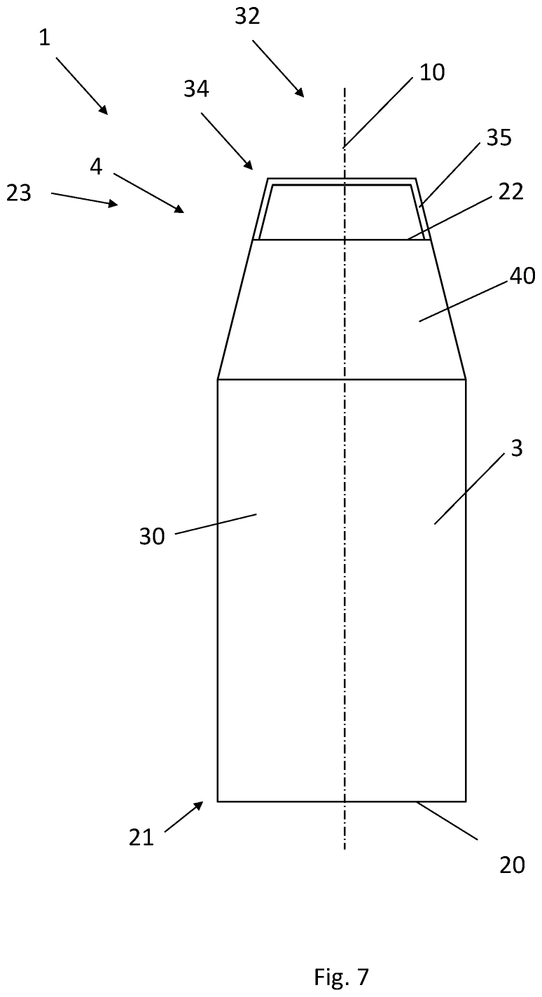

FIG. 7 shows a schematic side view of a device 1 for the contacting of a first battery unit 6 and a second battery unit 7 according to a further embodiment. The device 1 has touch protection 34 with a frame structure 34 according to FIGS. 3 and 4. The device 1 moreover has an insertion portion 4, which is not only formed by the frame structure 34 but likewise extends over the guide element 3. The insertion portion 4 consequently has a form in the manner of a truncated pyramid, wherein the insertion portion 4 is formed by the region of the guide element 3 which is provided with a phase 40 and the frame structure 34, consequently the touch protection 32.

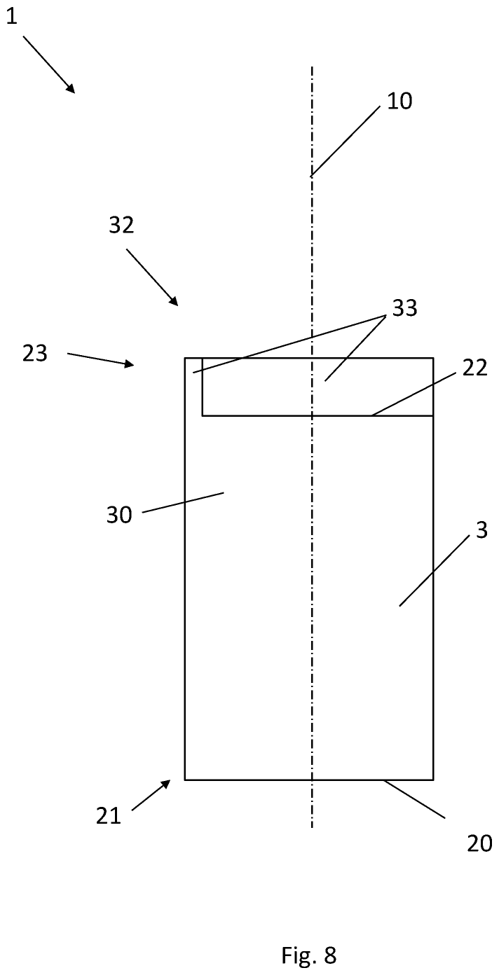

FIG. 8 shows a schematic side view of a device 1 for the contacting of a first battery unit 6 and a second battery unit 7 according to a further embodiment. The touch protection 32 here is provided in the form of side walls 33 which extend beyond the second contact surface 22 in the axial direction 10 on three sides and which, in the present case, are likewise formed from the material of the guide element 3. In other words, the guide element 3 extends beyond the second contact surface via the side walls 33.

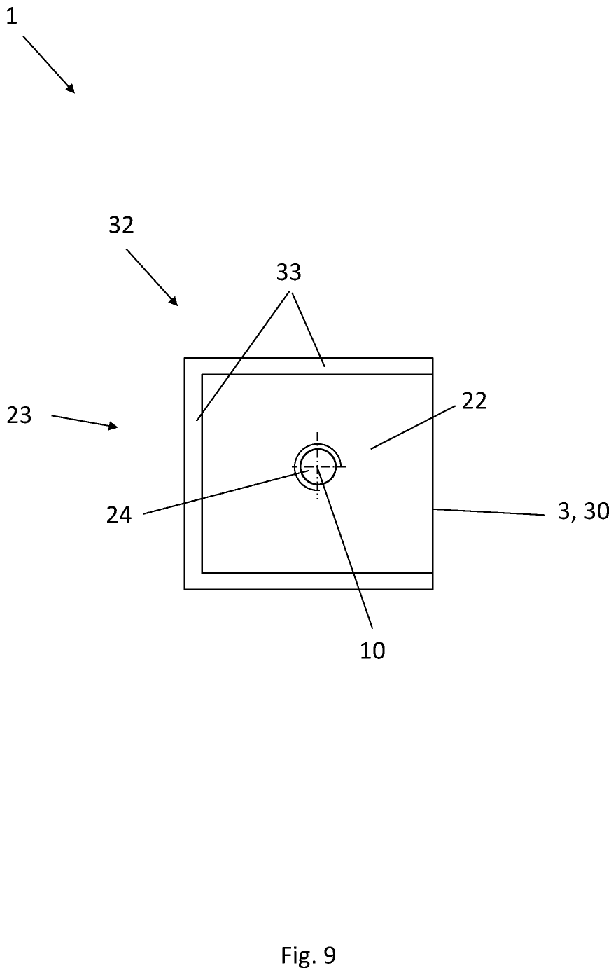

A schematic plan view of the device of FIG. 8 is shown in FIG. 9. The side walls 33 form a pocket-like receptacle for the second contacting element 70 with the second contact surface 22.

The end face can alternatively be at least partially covered at the end of the three side walls 33 and/or it can have a frame structure 32, so that a lateral insertion opening is in turn provided. The insertion opening can alternatively also be aligned in the axial direction 10.

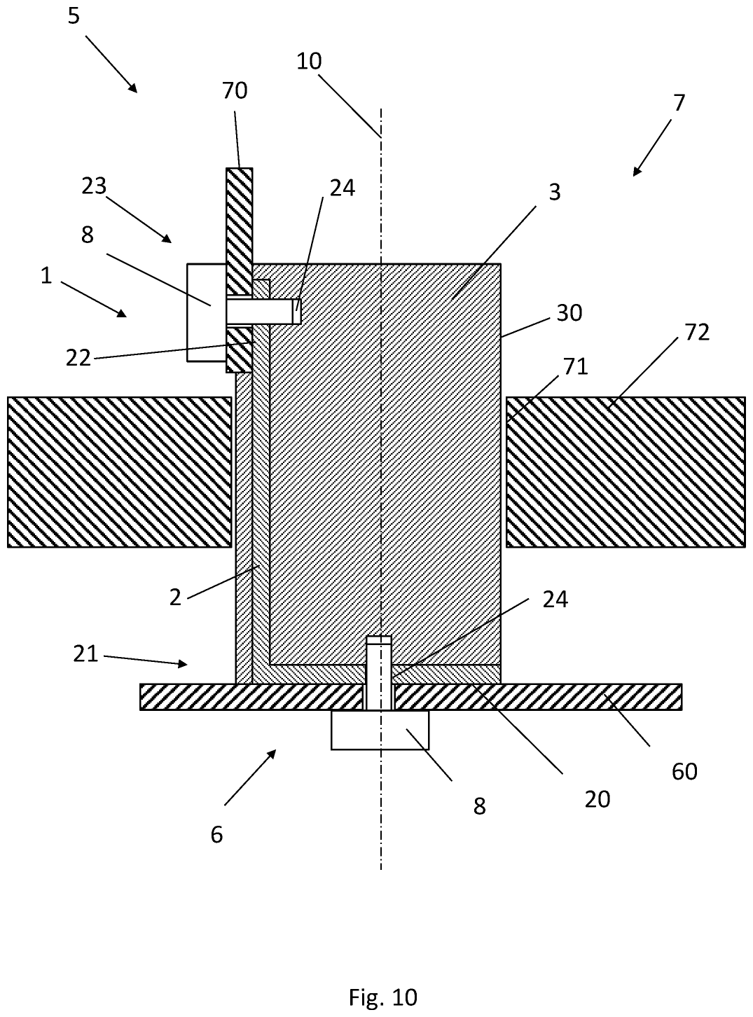

FIG. 10 shows a schematic sectional view of a battery arrangement 5 according to a further embodiment. This corresponds substantially to that described in FIG. 2, wherein the second contact surface of the device 1 is not arranged at an end face of the second end 23 here but is provided laterally on the second end 23.

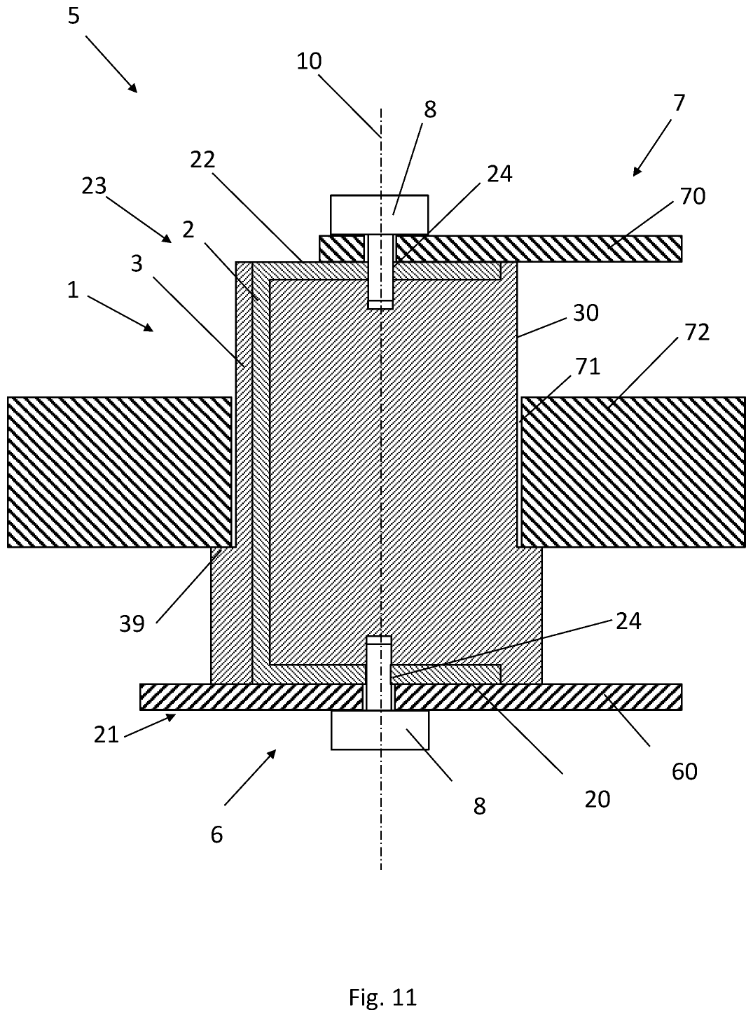

FIG. 11 shows a schematic sectional view of a battery arrangement 5 according to a further embodiment, which corresponds substantially to that of FIG. 2. The guide element 3 of the device 1 furthermore has a shoulder 39 here, by means of which a defined spacing between the first battery unit 6 and the second battery unit 7 can be provided.

FIGS. 12A to 12F show schematic views of various embodiments of outer cross-sectional profiles 31 of the guide element 3 according to preferred embodiments of the device 1.

FIG. 12A shows an outer cross-sectional profile 31 with a polygonal form, which corresponds substantially to a rectangle with rounded corners.

FIG. 12B shows an outer cross-sectional profile 31 with an ellipsoidal form, which corresponds to a quadrangle with correspondingly rounded corners.

FIG. 12C shows a substantially circular outer cross-sectional profile 31.

FIG. 12D shows an outer cross-sectional profile 31 with a polygonal form, which corresponds substantially to a triangle. According to a preferred development, corners of the triangle are rounded.

FIG. 12E shows an outer cross-sectional profile 31 with a polygonal form, which corresponds substantially to a hexagon.

FIG. 12F shows an outer cross-sectional profile 31, which is based substantially on the outer cross-sectional profile 31 shown in FIG. 12E, wherein the corners of the hexagon are rounded.

Where applicable, all individual features which are illustrated in the exemplary embodiments may be combined and/or interchanged with one another without deviating from the scope of the invention.

### LIST OF REFERENCE SIGNS

1 Device
10 Axial direction
2 Electrically conductive element
20 First contact surface
21 First end
22 Second contact surface
23 Second end
24 Threaded bore
3 Guide element
30 Guide surface
31 Outer cross-sectional profile
32 Touch protection
33 Side wall
34 Frame structure
35 Rod
36 Insertion opening
37 Height
38 Width
39 Shoulder
4 Insertion opening
40 Phase
5 Battery arrangement
6 First battery unit
60 First contacting element
7 Second battery unit
70 Second contacting element
71 Opening
72 Base element
8 Screw

1. A device for establishing contact between a first battery unit and a second battery unit, comprising
an electrically conductive element, which has, at a first end, a first contact surface for electrically contacting the first battery unit and, at a second end, a second contact surface for electrically contacting the second battery unit, and
a guide element extending between the first contact surface and the second contact surface in the axial direction,
wherein the guide element has a guide surface for guiding the second battery unit in an axial direction relative to the first battery unit during the assembly of the first battery unit and the second battery unit, and
wherein the guide element is designed as electrical insulation of the conductive element.

2. The device as claimed in claim 1, wherein the guide element is formed continuously in the circumferential direction with respect to the axial direction.

3. The device as claimed in claim 2, wherein the guide element has an outer cross-sectional profile, the form of which is designed in such a way that, in addition to the guidance of the second battery unit in the axial direction, a positioning of the second battery unit relative to the first battery unit is provided.

4. The device as claimed in claim 3, wherein the outer cross-sectional profile has a polygonal form.

5. The device as claimed in claim 4, wherein a touch protection extends beyond the second contact surface in the axial direction.

6. The device as claimed in claim 5, wherein the touch protection has at least one of: a side wall extending from the second contact surface and a frame structure.

7. The device as claimed in claim 6, wherein the touch protection has an insertion opening for inserting a second contacting element of the second battery unit.

8. The device as claimed in claim 7, wherein a fastening element is configured to provide at least one of: a mechanical connection and a mechanical and electrical connection, is provided on at least one of: the first contact surface and a fastening element for providing at least one of: a mechanical connection and a mechanical and electrical connection, is provided on the second contact surface.

9. The device as claimed in claim 8, wherein the guide element has an insertion portion extending from the second end in the direction of the first end.

10. A battery arrangement, comprising a first battery unit and a second battery unit, wherein the second battery unit is positioned relative to the first battery unit by a device, and wherein the first battery unit and the second battery unit establish electrical contact via the device.

11. The battery arrangement as claimed in claim 10, wherein the second battery unit is arranged above the first battery unit.

12. The battery arrangement as claimed in claim 11, wherein the device extends from the first battery unit through an opening in a base element of the second battery arrangement in the direction of the second battery arrangement.

13. The battery arrangement as claimed in claim 10, wherein the device comprises:
an electrically conductive element, which has, at a first end, a first contact surface for electrically contacting the first battery unit and, at a second end, a second contact surface for electrically contacting the second battery unit, and
a guide element extending between the first contact surface and the second contact surface in the axial direction,
wherein the guide element has a guide surface for guiding the second battery unit in an axial direction relative to the first battery unit during the assembly of the first battery unit and the second battery unit, and
wherein the guide element is designed as electrical insulation of the conductive element.

14. The device as claimed in claim 1, wherein the guide element comprises an electrically insulating material.

15. The device as claimed in claim 3, wherein the positioning of the second battery unit relative to the first battery unit is an angular positioning in relation to the axial direction in the circumferential direction.

16. The device as claimed in claim 4, wherein the polygonal form of the outer cross-sectional profile is at least one of: a substantially triangular, quadrangular or hexagonal form, and wherein at least one corner of the polygonal outer cross-sectional profile is rounded.

17. The device as claimed in claim 6, wherein the frame structure-is a rod frame structure.

18. The device as claimed in claim 7, wherein a height and a width of the insertion opening are each designed to be greater than a height and a width of the second contacting element, and wherein the insertion opening is formed laterally.

19. The device as claimed in claim 8, wherein the fastening element comprises at least one of: a threaded bore and a threaded pin.

20. The device as claimed in claim 9, wherein the insertion portion tapers in the direction of the second end, wherein the insertion portion is designed to be at least one of: at least partially conical, pyramidal in the manner of at least one of: a truncated cone and a truncated pyramid, and have at least one phase.
